(19) United States
(12) Patent Application Publication
(10) Pub. No.: US 2015/0363044 A1
(43) Pub. Date: Dec. 17, 2015

(54) GESTURE IDENTIFICATION SYSTEM IN TABLET PROJECTOR AND GESTURE IDENTIFICATION METHOD THEREOF

(71) Applicants: Shui Ho Hung, Taipei City (TW); Huei Lin Wong, (US)

(72) Inventor: Shui Ho Hung, TAIPEI CITY (TW)

(21) Appl. No.: 14/459,465

(22) Filed: Aug. 14, 2014

Related U.S. Application Data
(60) Provisional application No. 62/012,117, filed on Jun. 13, 2014.

(51) Int. Cl. G06F 3/042; G06F 3/041; G06F 3/0488; G09G 5/18; G06F 3/01

(52) U.S. Cl. CPC G06F 3/0421; G09G 5/18; G06F 3/017; G06F 3/04883; G06F 3/0416

(57) ABSTRACT

A gesture identification system in tablet projector and a gesture identification method thereof are provided. The gesture identification system comprises a processing unit, a touch panel, an image projection module and an optical detection module, the processing unit is configured for executing an application program, the touch panel is coupled to the processing unit and configured for receiving a control motion, the processing unit is configured for identifying the control motion as a control instruction, executing the control instruction and generating an execution result through the application program; the image projection module is coupled to the processing unit and configured for projecting an image information according to the execution result; and the optical detection module is coupled to the processing unit and configured for generating a detection signal corresponding to a detection result, wherein the processing unit is configured for identifying the detection signal as a gesture instruction, executing the gesture instruction and generating the execution result through the application program, the image projection is configured for re-projecting the image information according to the execution result.

### CROSS-REFERENCE TO RELATED APPLICATIONS

This application claims the benefit of the filing date of U.S. Provisional Application No. 62/012,117, filed on 2014 Jun. 13, in the United States Patent and Trademark Office, the disclosure of which is incorporated herein in its entirety by reference.

### BACKGROUND OF THE INVENTION

1. Technical Field

The present invention relates to an identification system and an identification method thereof, and more particularly to a gesture identification system in tablet projector and a gesture identification method thereof.

2. Description of Related Art

As rapid development of display technology, various new display device are getting rid of the stale and bringing forth the fresh, new products such as liquid crystal display (LCD), digital television, digital projector. Meanwhile, entirely separate development trend is derived in specific display device corresponding to different demands of consumers. One of development trend is family entertainment, to satisfy such demand, development of home display device, such as liquid crystal display (LCD), digital television, digital projector, etc are targeted in big-scale, high definition, high resolution and 3D imaging.

In another aspect, the other development trend is directed to personal use or commercial applications wherein convenience is no doubt a main subject. Hence, portable, mobility, multiple-function and power-saving are taking serious consideration in tablet computer, personal display device or small projector in order to be applied for personal use or commercial applications. Therefore, a tablet projector with both functions of tablet computer and projector integration is involved.

The advantages of the tablet projector includes: the tablet projector may perform like a normal tablet computer in common use, and the tablet projector may also project an image information in order to share with other viewers during commercial exhibition, presentation or image sharing, it is to say, it is convenient and fully satisfying user's different requirement with one tablet projector. Hence, a tablet projector has become a leading product in the market which is well-received by the public.

To the conventional tablet projector, it still relies on physical buttons or the touch panel therein for operation. Users usually have to get close to the tablet projector and hold it in hands during operation according its small size, and get apart from it after usage to avoid blocking audience's view. Additionally, frequently movement of the tablet projector may cause projection suspended and becomes a serious interruption for audience as users try to provide a commercial exhibition, a presentation or an image sharing as mentioned above.

In view of the foregoing, there exist problems and disadvantages in the related art still unsolved. However, those skilled in the art sought vainly for a solution. There is an urgent need in the related field to provide a new operation method for the tablet projector.

### BRIEF SUMMARY OF THE INVENTION

In view of the above, the primary objective of the present invention is to provide an identification system in tablet projector and an identification method thereof so as to resolve defects such as inconveniences and interruptions caused by conventional hand-held operation of the tablet projector and projection disruption derived therein.

The following presents a simplified summary of the disclosure in order to provide a basic understanding to the reader. This summary is not an extensive overview of the disclosure and it does not identify key/critical components of the present invention or delineate the scope of the present invention. Its sole purpose is to present some concepts disclosed herein in a simplified form as a prelude to the more detailed description that is presented later.

In one exemplary embodiment, the invention is directed to a gesture identification system in tablet projector, the gesture identification system comprises a processing unit, a touch panel, an image projection module and an optical detection module, the processing unit is configured for executing an application program, the touch panel is coupled to the processing unit and configured for receiving a control motion, the processing unit is configured for identifying the control motion as a control instruction, executing the control instruction and generating an execution result through the application program; the image projection module is coupled to the processing unit and configured for projecting an image information according to the execution result; and the optical detection module is coupled to the processing unit and configured for generating a detection signal corresponding to a detection result, wherein the processing unit is configured for identifying the detection signal as a gesture instruction, executing the gesture instruction and generating the execution result through the application program, the image projection is configured for re-projecting the image information according to the execution result.

In another exemplary embodiment of mentioned gesture identification system in tablet projector, wherein the optical detection module further comprises a first optical detection element and a second optical detection element, the first optical detection element and the second optical detection element are configured for generating the detection results respectively, and the optical detection module is configured for combining the detection results and generating the detection signal accordingly.

In another exemplary embodiment, mentioned gesture identification system in tablet projector further comprises a timer, the timer is coupled to the processing unit and configured for generating a clock signal periodically, wherein the processing unit is configured for determining whether the detection signal corresponds to the gesture instruction according to the detection signal and the clock signal as identifying the detection signal.

According to the exemplary embodiment of the present disclosure, the invention is also directed to a gesture identification method in a tablet projector, comprises following steps: executing an application program via a processing unit; receiving a control motion via a touch panel; identifying the control motion as a control instruction via the processing unit, executing the control instruction and generating an execution result through the application program; projecting an image information according to the execution result via an image projection module; generating a detection signal corresponding to a detection result via an optical detection module; and identifying the detection signal via the processing unit, wherein if the control signal is determined as a gesture instruction, the processing unit executes the gesture instruction and generates the execution result through the application program, and the image projection module re-projects the image information according to the execution result, wherein if the control signal is determined not as a gesture instruction, the processing unit is deactivated.

In another exemplary embodiment of mentioned gesture identification method, wherein in the step of generating the detection signal corresponding to the detection result via the optical detection module further comprises: generating the detection result via a first optical detection element and a second optical detection element of the optical detection module respectively; and combining the detection result and generating the detection signal via the optical detection module accordingly.

In another exemplary embodiment, mentioned gesture identification method further comprises: generating a clock signal via a timer periodically, wherein the processing unit determines whether the detection signal corresponds to the gesture instruction according to the detection signal and the clock signal during the detection signal's identification.

In another exemplary embodiment of mentioned gesture identification method, wherein if the processing unit determines a cover motion is detected by the first optical detection element during a time period, the processing unit determines detection signal as an enter gesture, executes an enter instruction and generates the execution result through the application program accordingly.

In another exemplary embodiment of mentioned gesture identification method, wherein if the processing unit determines the cover motion is detected by the second optical detection element during the time period, the processing unit determines detection signal as a dialogue gesture, executes a dialogue instruction and generates the execution result through the application program accordingly.

In another exemplary embodiment of mentioned gesture identification method, wherein if the processing unit determines the cover motion is detected by the first optical detection element and the second optical detection element simultaneously during the time period, the processing unit determines detection signal as a full-screen gesture, executes a full-screen instruction and generates the execution result through the application program accordingly.

In another exemplary embodiment of mentioned gesture identification method, wherein if the processing unit determines the cover motion is detected by the first optical detection element and the second optical detection element sequentially during the time period, the processing unit determines detection signal as a sliding gesture, executes a sliding instruction and generates the execution result through the application program accordingly.

In view of the foregoing, the technical solutions of the present disclosure result in significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:

Firstly, through continuous detection for user's cover motion by the optical detection module of mentioned gesture identification system, users are available to operate the tablet projector without moving or holding it during commercial exhibition, presentation or image sharing. Meanwhile, according to sufficient detection range of the optical detection module, users can operate the tablet projector even without getting close to it so as to improve user's convenience remarkably.

Besides, since users can operate the tablet projector without moving it, the projection image will not be interrupted and visual sense of audiences may not be disturbed, correspondingly, overall visual enjoyment is improved.

Furthermore, various user's cover motion can be detected by the optical detection elements of the optical detection module in the tablet projector and identified as different gesture instructions, operating function in mentioned gesture identification and gesture identification method thereof can be expanded according to user's demand in order to simplify user's operation. Consequently, usage intention is expected to be promoted.

Many of the attendant features will be more readily appreciated, as the same becomes better understood by reference to the following detailed description considered in connection with the accompanying drawings.

### BRIEF DESCRIPTION OF THE DRAWINGS

The invention can be more fully understood by reading the subsequent detailed description and examples with references made to the accompanying drawings, wherein:

FIG. 1 is a structural diagram illustrating a gesture identification system in tablet projector according to an exemplary embodiment of the present invention;

FIG. 2 is a functional block diagram illustrating the gesture identification system in tablet projector according to the exemplary embodiment of the present invention;

FIG. 3A is part of a flow chart illustrating a gesture identification method in tablet projector according to an exemplary embodiment of the present invention;

FIG. 3B is another part of the flow chart illustrating the gesture identification method in tablet projector according to the exemplary embodiment of the present invention;

FIG. 4A is a schematic diagram illustrating a gesture identification method in tablet projector according to an exemplary embodiment of the present invention;

FIG. 4B is a schematic diagram illustrating the gesture identification method in tablet projector according to the exemplary embodiment of the present invention;

FIG. 5A is a schematic diagram illustrating a gesture identification method in tablet projector according to an exemplary embodiment of the present invention;

FIG. 5B is a schematic diagram illustrating the gesture identification method in tablet projector according to the exemplary embodiment of the present invention;

FIG. 6A is a schematic diagram illustrating a gesture identification method in tablet projector according to an exemplary embodiment of the present invention;

FIG. 6B is a schematic diagram illustrating the gesture identification method in tablet projector according to the exemplary embodiment of the present invention;

FIG. 7A is a schematic diagram illustrating a gesture identification method in tablet projector according to an exemplary embodiment of the present invention;

FIG. 7B is a schematic diagram illustrating the gesture identification method in tablet projector according to the exemplary embodiment of the present invention;

FIG. 7C is a schematic diagram illustrating a gesture identification method in tablet projector according to an exemplary embodiment of the present invention; and

FIG. 7D is a schematic diagram illustrating the gesture identification method in tablet projector according to the exemplary embodiment of the present invention.

### DETAILED DESCRIPTION OF THE INVENTION

The detailed description and technical contents of the present invention will be explained with reference to the accompanying drawings. However, the drawings are for illustration only and cannot be used to limit the present invention.

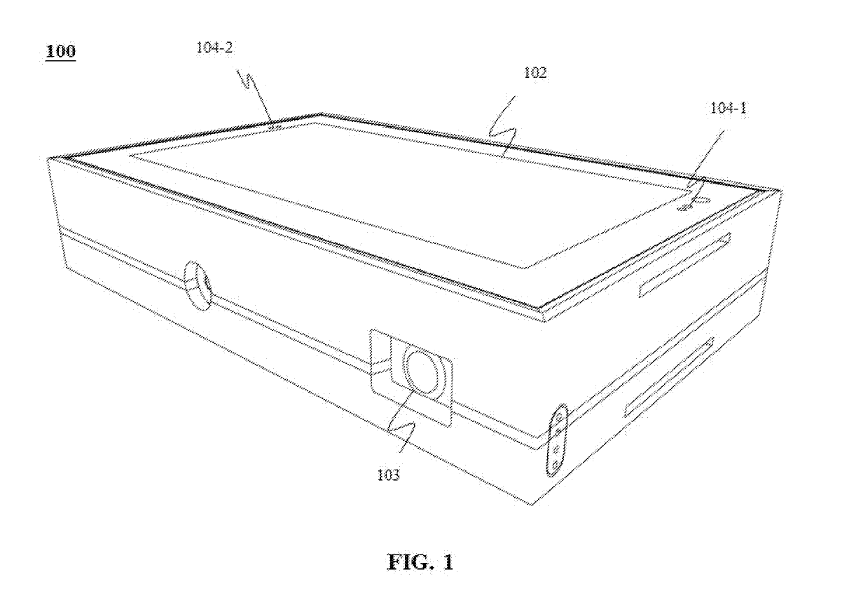

Several exemplary embodiments of the present disclosure are described with reference to FIGS. 1 through 7D, which generally relate to a gesture identification system in a tablet projector and a gesture identification method thereof. It should be understood that the following disclosure provides various embodiments as examples for implementing different features of the present disclosure. Specific examples of components and arrangements are described in the following to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various described embodiments and/or configurations.

It will be understood that, in the description herein and throughout the claims that follow, when an element is referred to as being “connected” or “electrically connected” to another element, it can be directly connected to the other element or intervening elements may be present. In contrast, when an element is referred to as being “directly connected” to another element, there are no intervening elements present. Moreover, “electrically connect” or “connect” can further refer to the interoperation or interaction between two or more elements.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the embodiments.

It will be understood that, in the description herein and throughout the claims that follow, the terms “comprise” or comprising,” “include” or “including,” “have” or “having,” “contain” or “containing” and the like used herein are to be understood to be open-ended, i.e., to mean including but not limited to.

It will be understood that, in the description herein and throughout the claims that follow, the phrase “and/or” includes any and all combinations of one or more of the associated listed items.

It will be understood that, in the description herein and throughout the claims that follow, unless otherwise defined, all terms (including technical and scientific terms) have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

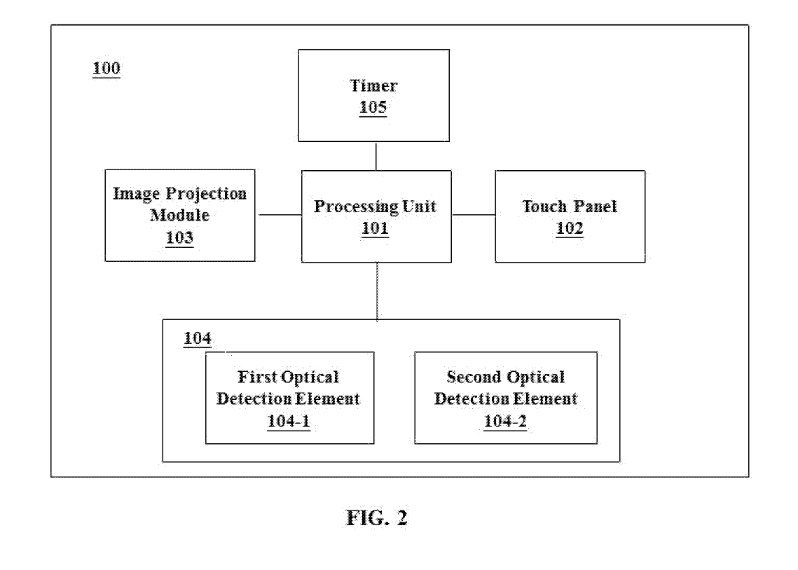

FIG. 1 to FIG. 2 are a structural diagram and a function block diagram illustrating a gesture identification system in tablet projector according to the present invention. Referring to FIG. 1 to FIG. 2, the gesture identification system 100 in the first embodiment can be but not limited to a mobile projector, a tablet computer or a laptop equipped with image projecting module. The gesture identification system 100 includes a processing unit 101, a touch panel 102, an image projection module 103, an optical detection module 104 and a timer 105. An application program is executed by the processing unit 101. The application program mentioned herein includes a window, an iOS, or an Android operating system software which is applied in a mobile projector, or other application programs for image viewing, text processing, video playing or other function based on mentioned operating system and is not limited.

As mentioned above, the touch panel 102 in the gesture identification system 100 electrically connects to the processing unit 101 and receives a control motion from user. The processing unit 101 determines the control motion as a control instruction, executes the control instruction and generates an execution result through the application program. The image projection module 103 electrically connects to the processing unit 101 and projects an image information according to the execution result. The optical detection module 104 which electrically connects to the processing unit 101 further includes a first optical detection element 104-1 and a second optical detection element 104-2. Those optical detection elements 104-1 and 104-2 mentioned herein can be an infra-red sensor, an optical coupler, a fiber optical sensor or other optical sensor and is not limited. Mentioned first optical detection element 104-1 and second optical detect ion element 104-2 generate different electronic signals accordingly by detecting whether light shielding is occurred. It is noted that type or amount of the optical detection elements is not restricted and can be modified or varied by people with ordinary skill in this art according to different requirement and design ideas without departing from the spirit of the present invention. The first optical detection element 104-1 and the second optical detection element 104-2 in present invention are equipped on different side of the mobile projector and generate a detection result and corresponding electronic signals by detecting whether light shielding is occurred respectively. The optical detection module 104 combines the electronic signals from the first optical detection element 104-1 and the second optical detection element 104-2 and generates a detection signal accordingly.

The timer 105 in the gesture identification system 100 electrically connects to the processing unit 101. The timer 105 generates a clock signal periodically, the processing unit 101 determines whether the detection signal corresponds to a gesture instruction according to the detection signal and the clock signal as identifying the detection signal. In other words, the processing unit 101 identifies the detection signal depending on following conditions: (1) whether the detection signal transmitted from the optical detection module 104 is detected during a time period, such as 2 seconds; and (2) whether the detection signal corresponds to the gesture instruction already saved in the processing unit 101. It is noted that the time period can be modified according to user's demand to avoid erroneous judgment from the optical detection module 104 induced by user's unintentional motions or false touch. Therefore, accuracy and efficiency of the processing unit 101 will be improved accordingly. Detailed gesture identification procedure will be elaborated in the following paragraphs.

As mentioned, if the processing unit 101 determines the detection signal corresponds to the gesture instruction, the processing unit 101 will executes the gesture instruction and generates the execution result through executing application program, or the application program which appointed by the gesture instruction. The image projection module 103 will re-projects the image information corresponding to the execution result. Besides, the execution result will be displayed on the touch panel 102 synchronously. It is to say, the execution result of the gesture instruction executed by the processing unit 101 will be appeared on both the touch panel 102 and the image information 201 re-projected by the image projection module 103 simultaneously for the synchronization purpose.

The gesture instruction mentioned therein includes various instructions executed in the computer system, such as entering, escaping, maximizing, minimizing, full-screening or other instructions. The gesture instruction can be appointed to different functions according to different application program, or the gesture instruction can be appointed as an exclusive instruction to the specified application program. Furthermore, the gesture instruction can also be appointed to the function similar to the right button or left button of the mouse and is not limited as described. It is noted that the gesture instructions and corresponding detection signals and execution instructions may be preset in a memory module of the tablet projector in advance, and the processing unit 101 may call the data saved in the memory module, Besides, users may also add a new gesture instruction to the memory module by the optical detection module 104 to be customized, personalized and exclusive to satisfy user's demands.

It is noted that the gesture identification system 100 illustrated in this embodiment may include other hardware components, such as image acquisition module, audio playback module or network connection module and is not limited as mentioned. The following description will focus on essential components in the gesture identification system 100 as shown in FIG. 1 and FIG. 2 for emphasizing the technical features of the present invention. It will also make the description of the present invention clear enough and fully disclosed for people with ordinary skill in this art to practice according thereto.

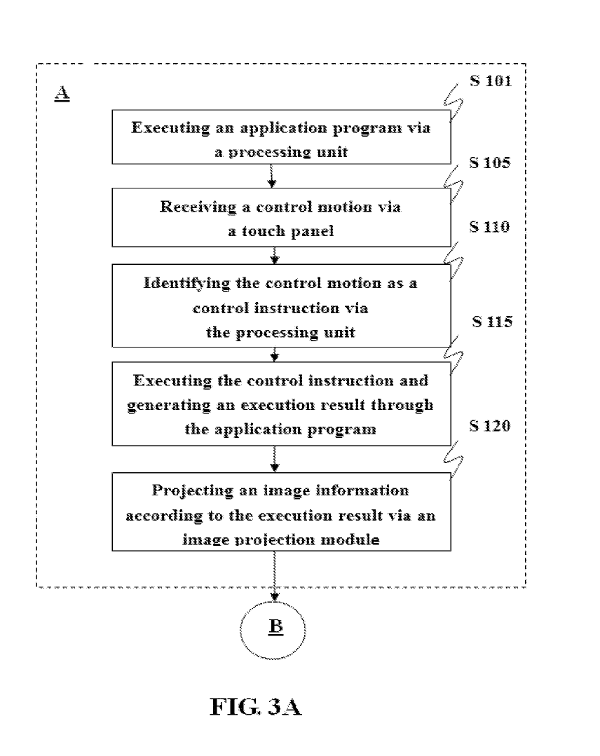

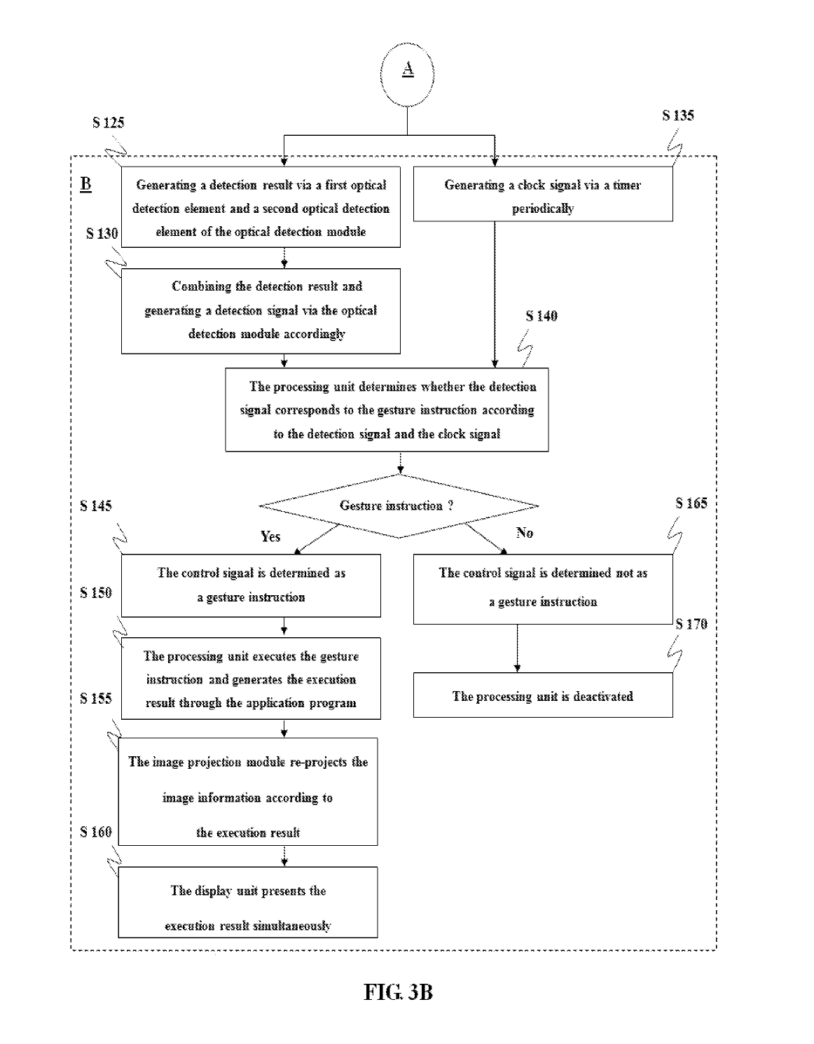

As mentioned above, please referring to FIGS. 3A and 3B, also referring to FIG. 1 and FIG. 2, when user operates the gesture identification method in the gesture identification system 100 in tablet projector, it can be divided in: (A) normal operating procedure; and (B) gesture operating procedure for following explanation.

As shown in FIG. 3A, when user decides to execute the normal operating procedure to commercial exhibition, presentation or image sharing, firstly, executing the application program via the processing unit 101 (S101), such as a presentation software, and receiving the control motion via the touch panel 102 (S105), for example, when touch panel 102 receives a left-sliding control motion, the left-sliding control motion will be transmitted to the processing unit 101, the processing unit 101 identifies the control motion as a control instruction (S110), for example, the left-sliding control motion represents to the next page instruction, the processing unit 101 will execute the control instruction and generate the execution result through the application program, therefore, the presentation software will generate the next page instruction accordingly, the image projection module 103 is controlled by the processing unit 101 and projects the image information according to the execution result (S120). Hence, the image information projected by the image projection module 103 will show page switching in the presentation documents, meanwhile, such page switching will also be appeared on the touch panel 102 synchronously. As result, all of user's operation will be processed and shown to the audience in synchronization.

Secondly, as shown in FIG. 3B, when user decides to operate gesture identification procedure (B) during commercial exhibition, presentation or image sharing, user only have to stay in detectable position, such as several meters, near the first optical detection element 104-1 and the second optical detection element 104-2 in the optical detection module 104 without touching the tablet projector. The gesture identification procedure will be described in the four following embodiments:

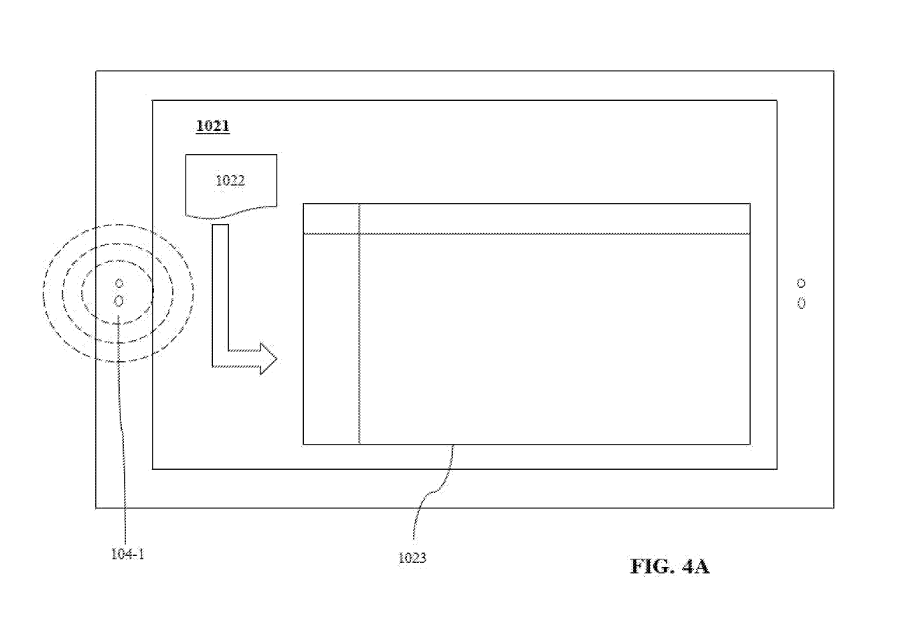

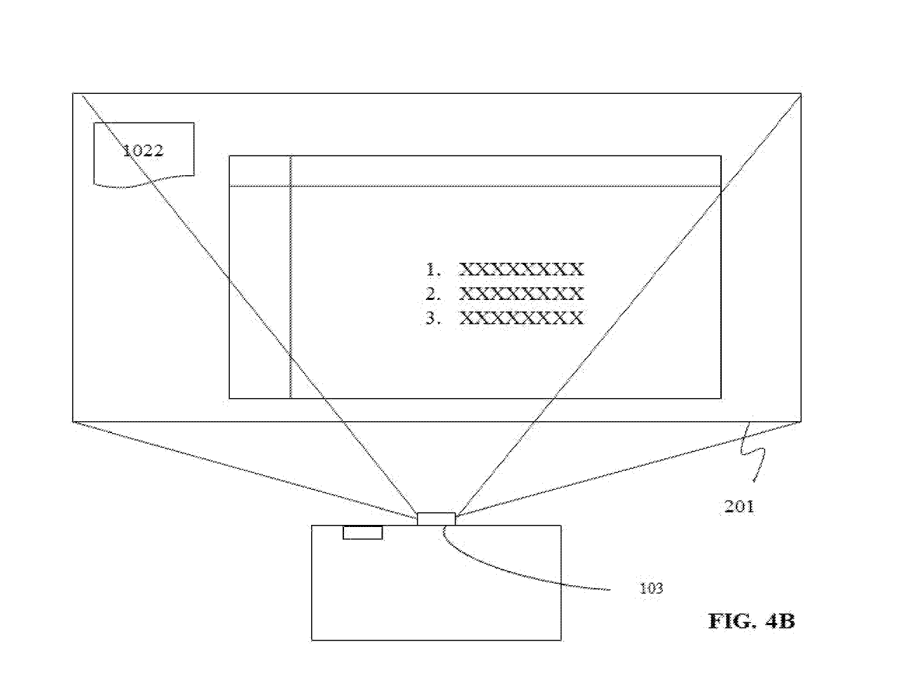

Please referring to FIG. 3B, 4A, 4B, in the first embodiment, when user wants to execute any shortcut 1022 in the application program, user only have to cover the first optical detection element 104-1 with hands or other objects. Since the first optical detection element 104-1 and the second optical detection element 104-2 is kept in the detection status, when the first optical detection element 104-1 detects a cover motion and the second optical detection element 104-2 does not detect the cover motion, the first optical detection element 104-1 and the second optical detection element 104-2 will generates the detection result respectively (S125), the optical detection module 104 will combine the electronic signal and generates the detection signal correspondingly (S130). Meanwhile, the timer 105 continues detecting the clock signal periodically (S135), the processing unit 101 determines whether the detection signal corresponds to the gesture instruction according to the detection signal and the clock signal (S104). In this embodiment, if the processing unit 101 determines the first optical detection element 104-1 detects the cover motion during the time period, such as 2 seconds, and the second optical detection element 104-2 fails to detects the cover motion during the same time period, the processing unit 101 will determines the detection signal corresponds to the gesture instruction (S145), and the processing unit 101 identifies the gesture instruction as an enter gesture, the processing unit 101 will execute the enter instruction corresponding to the gesture instruction to the executing application program, such as the shortcut 1022 on an execution interface 1021 in the operating system and generates execution result accordingly (S150). Hence, the shortcut 1022 will be clicked and the execution windows 1023 corresponding to the application program will be run. As mentioned above, the image projection module 103 is controlled by the processing unit 101 and will re-project the image information 201 according to the execution result as shown in FIG. 4B (S155). Meanwhile, as the touch panel 102 will appear the execution result simultaneously (S160).

On the contrary, if the processing unit 101 determines that the first optical detection element 1041 and/or the second optical detection element 104-2 is not detected during mentioned time period, or the detection signal does not correspond to the detection signal set inside, the processing unit 101 determines the detection signal is not the gesture instruction (S165), the processing unit 101 is deactivated accordingly (S170). Therefore, user's unintentional motions, false touch or shadow passed around the tablet projector which induces temperate cover to the first optical detection element 104-1 and the second optical detection element 104-2 will not be misjudged as the gesture instruction, accordingly, accuracy and efficiency of the gesture identification method is improved remarkably.

As result, in this embodiment, when user decide to click the Shortcut 1022 on the execution interface 1021 to execute the enter instruction, he/she only have to cover the first optical detection element 104-1 with his/her hand or other objects, the processing unit 101 will execute the clicking instruction to the shortcut 1022, activate the execution window 1023 of the application program, the execution result will appeared on the touch panel 102 and the image information 201 projected by the image projection module 103. It is really convenient.

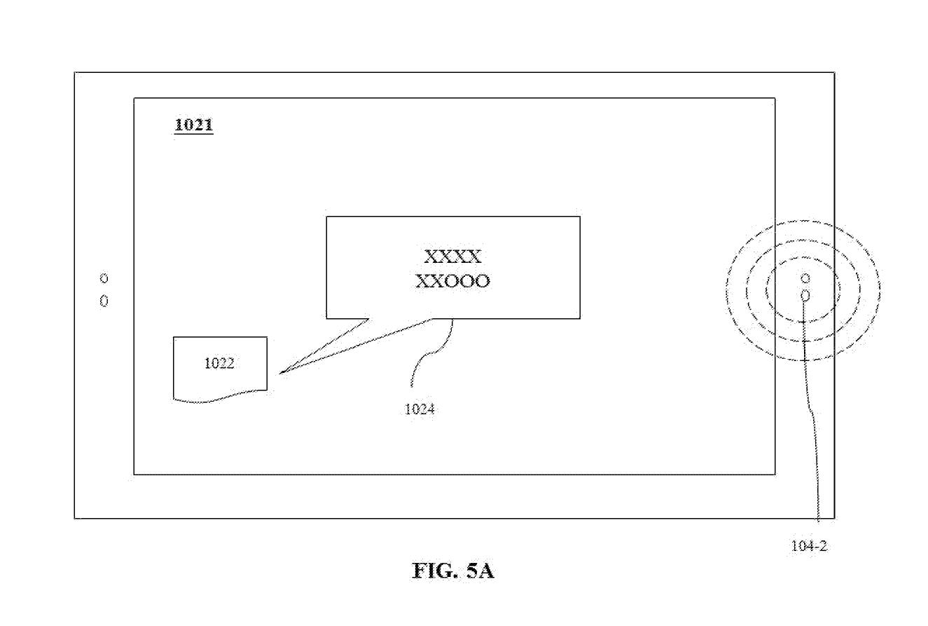

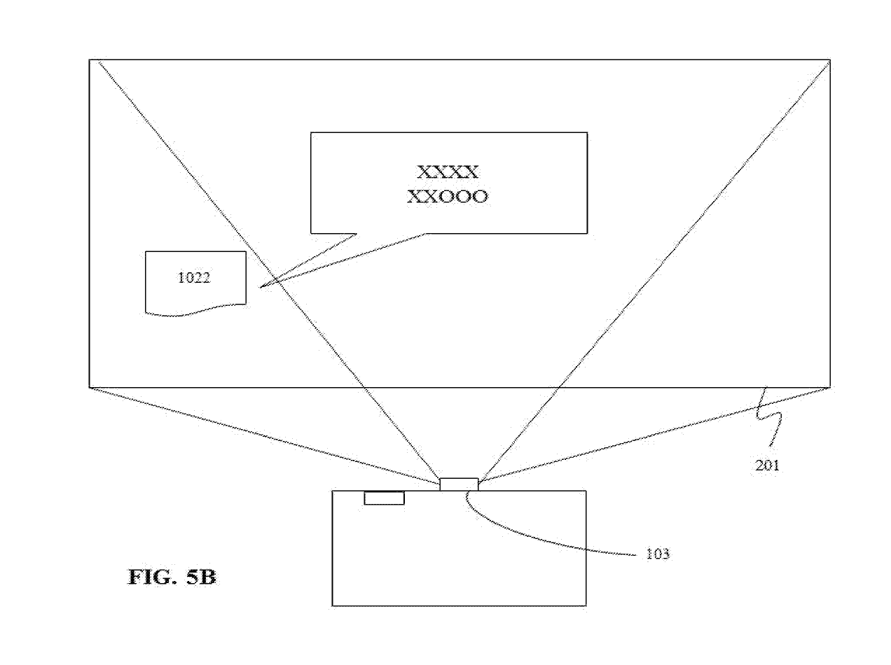

Please referring to FIG. 3B, 5A, 5B, in the second embodiment, when user decide to activate a dialogue window 1024 of any shortcut 1022 corresponding to the application program, he/she just have to cover the second optical detection element 104-2 with his/her hand or other objects as shown in FIG. 5A. The detection procedure performed by the first optical detection element 104-1 and the second optical detection element 104-2 in the optical detection module 104, the calculation procedure performed by the timer 105, the identification procedure performed by the processing unit 101 and the appearance procedure performed by the image projection module 103 and the touch panel 102 is similar to mentioned procedure in the first embodiment (S125-S170) and will not be repeated again. Difference between this embodiment and the first embodiment is that the first optical detection element 104-1 fails to detect the cover motion and the second optical detection element 104-2 detect the cover motion, the processing unit 101 will identify the detection signal as a dialogue instruction and execute the dialogue instruction to the application program, for example, the dialogue instruction corresponding to the gesture instruction will be executed to the shortcut 1022 on the execution interface 1021, and a dialogue window 1024 of the application program corresponding to the shortcut 1022 will be activated accordingly. Similar to the first embodiment, the execution result will also appeared on the touch panel 102 and the image information 201 re-projected by the image projection module 103 in synchronization.

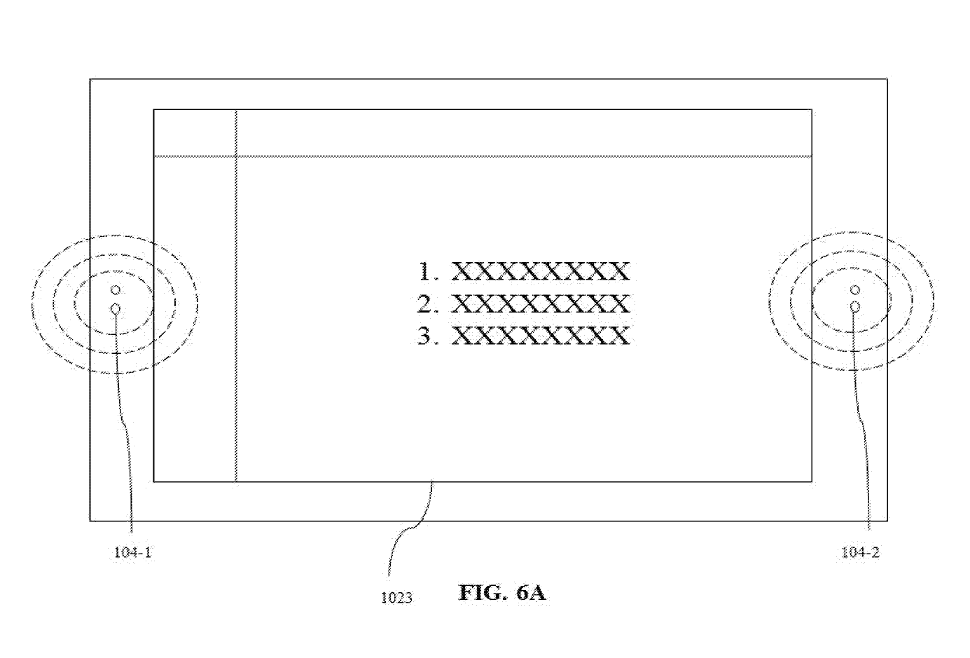

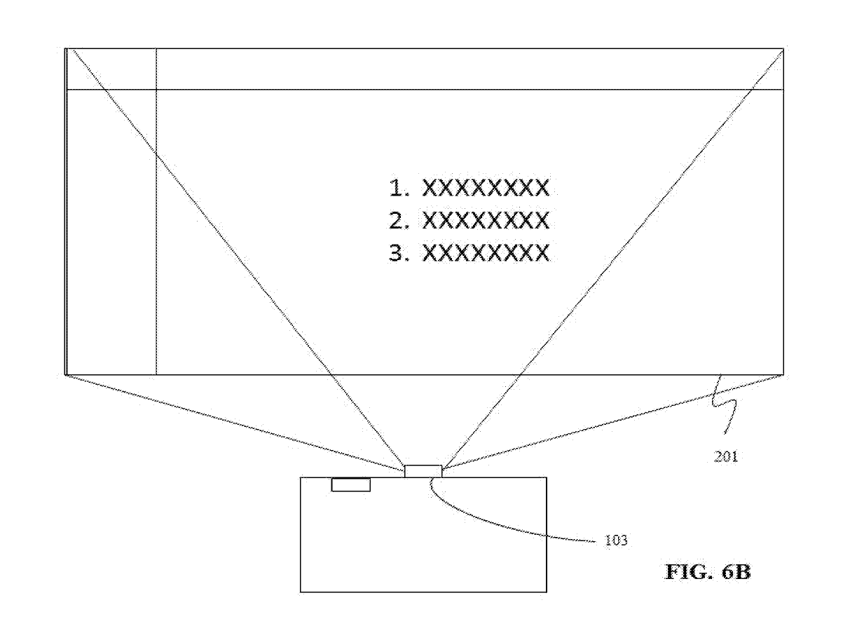

Please referring to FIGS. 3B, 6A and 6B, in the third embodiment, when user decide to activate a full-screen function of the execution window 1023 corresponding to the application program, he/she just have to cover the first optical detection element 104-1 and the second optical detection element 104-2 with his/her hand or other objects simultaneously as shown in FIG. 6A. The detection procedure performed by the first optical detection element 104-1 and the second optical detection element 104-2 in the optical detection module 104, the calculation procedure performed by the timer 105, the identification procedure performed by the processing unit 101 and the appearance procedure performed by the image projection module 103 and the touch panel 102 is similar to mentioned procedure in the first embodiment (S125-S170) and will not be repeated again. Difference between this embodiment and the first embodiment is that both the first optical detection element 104-1 and the second optical detection element 104-2 detect the cover motion simultaneously, the processing unit 101 will identify the detection signal as a full-screen instruction and execute the full-screen function to the application program, and similar to the first embodiment, the execution result will also appeared on the touch panel 102 and the image information 201 re-projected by the image projection module 103 in synchronization accordingly.

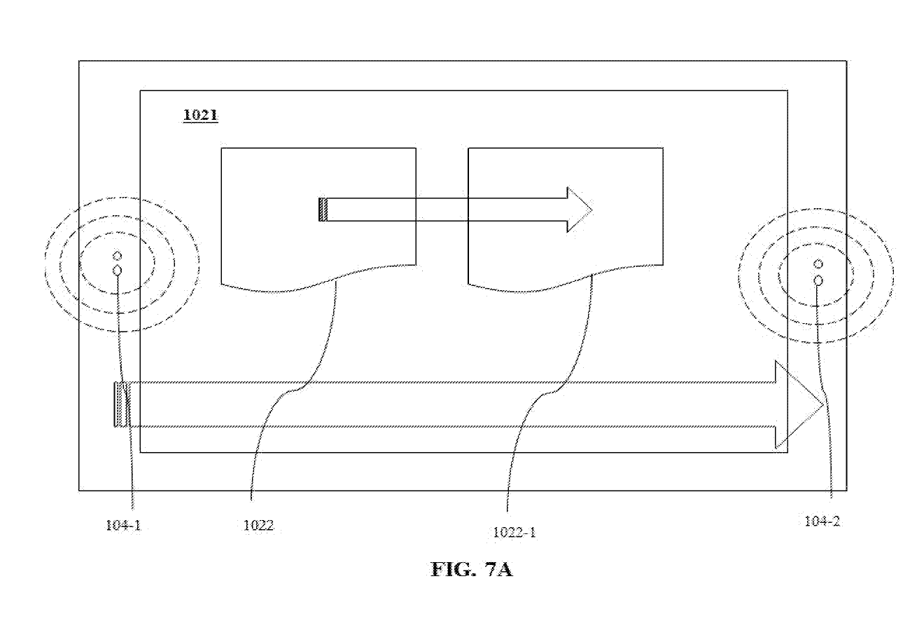

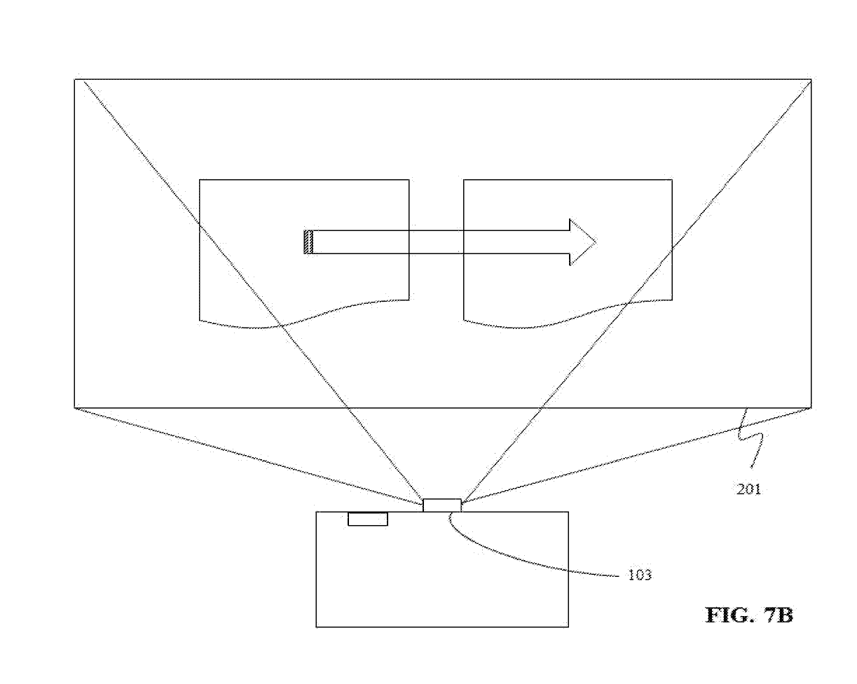

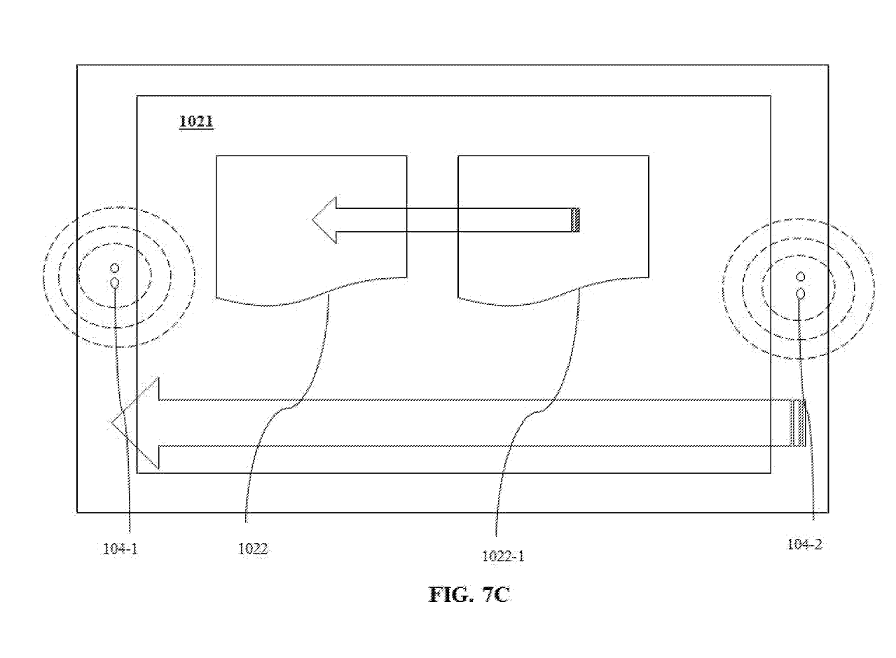

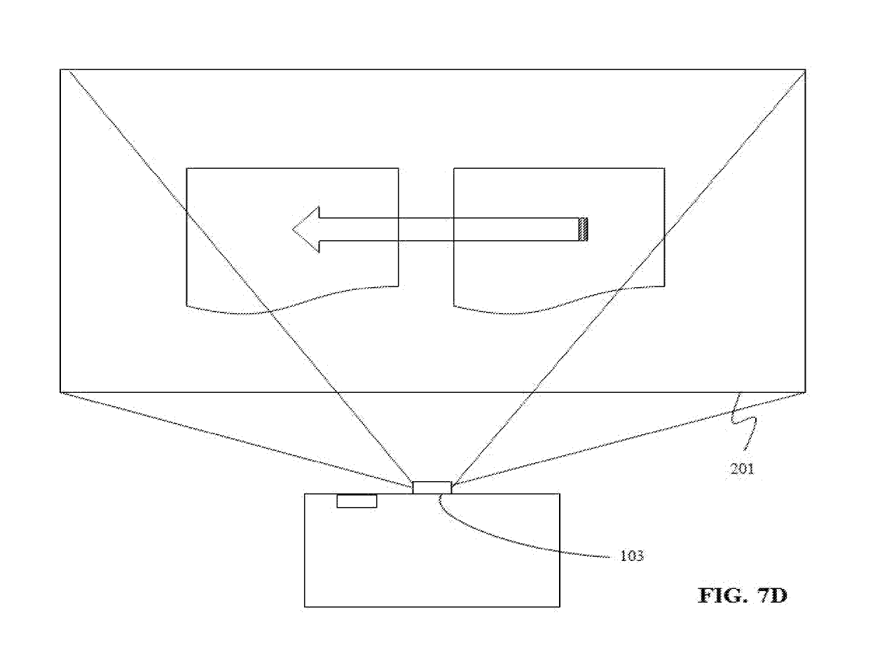

Please referring to FIG. 3B, 7A to 7D, in the fourth embodiment, when user decide to move any shortcut 1022 on the execution interface 1021 of the operating system, he/she just have to perform a sliding motion from the first optical detection element 104-1 to the second optical detection element 104-2 with his/her hand or other objects as shown in FIG. 7A or perform such sliding motion in a reversed direction as shown in FIG. 7C. Accordingly, the first optical detection element 104-1 and the second optical detection element 104-2 will detect the cover motion sequentially during the time period. The detection procedure performed by the first optical detection element 104-1 and the second optical detection element 104-2 in the optical detection module 104, the calculation procedure performed by the timer 105, the identification procedure performed by the processing unit 101 and the appearance procedure performed by the image projection module 103 and the touch panel 102 is similar to mentioned procedure in the first embodiment (S125-S170) and will not be repeated again. Difference between this embodiment and the first embodiment is that the first optical detection element 104-1 and the second optical detection element 104-2 detect the cover motion sequentially during the time period, if user performs a sliding motion from left to right, the first optical detection element 104-1 will detect the cover motion first, and so will the second optical detection element 104-2 then as shown in FIG. 7A; or if user performs a sliding motion from right to left, the second optical detection element 104-2 will detect the cover motion first, and so will the first optical detection element 104-1 then as shown in FIG. 7C. As mentioned above, the processing unit 101 will identify such detection signal relates to such sequential cover motion as a sliding instruction and execute a movement function to any shortcut 1022 on the execution interface 1021 of the operating system, for example, moving the shortcut from the original position 1022 to the new position 1022-1 as shown in FIG. 7A, or moving the shortcut from the original position 1022-1 to the new position 1022 as shown in FIG. 7C, and similar to the first embodiment, the execution result will also appeared on the touch panel 102 and the image information 201 re-projected by the image projection module 103 in synchronization accordingly, the processing unit 101 determines detection signal as a sliding gesture, executes a sliding instruction and generates the execution result through the application program accordingly. The sliding gesture can also be applied to copy and paste function to the shortcut 1022 or execution window 1023 on the execution interface 1021.

It is noted that the gesture instructions mentioned in different embodiment are merely several illustrations and not limited. People with ordinary skills in the art may develop or deduct various gesture instructions as their demands without departing from the spirit of the present invention to achieve purpose of the gesture operation.

In view of the foregoing, the technical solutions of the present disclosure result in significant advantageous and beneficial effects, compared with existing techniques. The implementation of the above-mentioned technical solutions achieves substantial technical improvements and provides utility that is widely applicable in the industry. Specifically, technical advantages generally attained, by embodiments of the present invention, include:

Firstly, through continuous detection for user's cover motion by the optical detection module of mentioned gesture identification system, users are available to operate the tablet projector without moving or holding it during commercial exhibition, presentation or image sharing. Meanwhile, according to sufficient detection range of the optical detection module, users can operate the tablet projector even without getting close to it so as to improve user's convenience remarkably.

Besides, since users can operate the tablet projector without moving it, the projecting image will not be interrupted and visual sense of audiences may not be disturbed, correspondingly, overall visual enjoyment is improved.

Furthermore, various user's cover motion can be detected by the optical detection elements of the optical detection module in the tablet projector and identified as different gesture instructions, operating function in mentioned gesture identification and gesture identification method thereof can be expanded according to user's demand in order to simplify user's operation. Consequently, usage intention is expected to promoted.

Although various embodiments of the invention have been described above with a certain degree of particularity, or with reference to one or more individual embodiments, they are not limiting to the scope of the present disclosure. Those with ordinary skill in the art could make numerous alterations to the disclosed embodiments without departing from the spirit or scope of this invention. Accordingly, the protection scope of the present disclosure shall be defined by the accompany embodiments.

What is claimed is:

1. A gesture identification system in tablet projector, comprising:
a processing unit, configured for executing an application program;
a touch panel, coupled to the processing unit, the touch panel configured for receiving a control motion, the processing unit configured for identifying the control motion as a control instruction, executing the control instruction and generating an execution result through the application program;
an image projection module, coupled to the processing unit, the image projection configured for projecting an image information according to the execution result; and
an optical detection module, coupled to the processing unit, the optical detection module configured for generating a detection signal corresponding to a detection result, wherein the processing unit is configured for identifying the detection signal as a gesture instruction, executing the gesture instruction and generating the execution result through the application program, the image projection is configured for re-projecting the image information according to the execution result.

2. The gesture identification system in tablet projector as claimed in claim 1, wherein the optical detection module further comprises a first optical detection element and a second optical detection element, the first optical detection element and the second optical detection element are configured for generating the detection results respectively, and the optical detection module is configured for combining the detection results and generating the detection signal accordingly.

3. The gesture identification system in tablet projector as claimed in claim 2 further comprising a timer, coupled to the processing unit, the timer configured for generates a clock signal periodically, wherein the processing unit is configured for determining whether the detection signal corresponds to the gesture instruction according to the detection signal and the clock signal as identifying the detection signal.

4. A gesture identification method applying for a tablet projector, comprising following steps:
executing an application program via a processing unit;
receiving a control motion via a touch panel;
identifying the control motion as a control instruction via the processing unit, executing the control instruction and generating an execution result through the application program;
projecting an image information according to the execution result via an image projection module;
generating a detection signal corresponding to a detection result via an optical detection module; and
identifying the detection signal via the processing unit, wherein if the control signal is determined as a gesture instruction, the processing unit executes the gesture instruction and generates the execution result through the application program, and the image projection module re-projects the image information according to the execution result, wherein if the control signal is determined not as a gesture instruction, the processing unit is deactivated.

5. The gesture identification method as claimed in claim 4, wherein in the step of generating the detection signal corresponding to the detection result via the optical detection module further comprises:
generating the detection result via a first optical detection element and a second optical detection element of the optical detection module respectively; and
combining the detection result and generating the detection signal via the optical detection module accordingly.

6. The gesture identification method as claimed in claim 5, further comprising:
generating a clock signal via a timer periodically, wherein the processing unit determines whether the detection signal corresponds to the gesture instruction according to the detection signal and the clock signal during the detection signal's identification.

7. The gesture identification method as claimed in claim 6, wherein if the processing unit determines a cover motion is detected by the first optical detection element during a time period, the processing unit determines detection signal as an Enter gesture, executes an Enter instruction and generates the execution result through the application program accordingly.

8. The gesture identification method as claimed in claim 7, wherein if the processing unit determines the cover motion is detected by the second optical detection element during the time period, the processing unit determines detection signal as a dialogue gesture, executes a dialogue instruction and generates the execution result through the application program accordingly.

9. The gesture identification method as claimed in claim 8, wherein if the processing unit determines the cover motion is detected by the first optical detection element and the second optical detection element simultaneously during the time period, the processing unit determines detection signal as a full-screen gesture, executes a full-screen instruction and generates the execution result through the application program accordingly.

10. The gesture identification method as claimed in claim 9, wherein if the processing unit determines the cover motion is detected by the first optical detection element and the second optical detection element sequentially during the time period, the processing unit determines detection signal as a sliding gesture, executes a sliding instruction and generates the execution result through the application program accordingly.
